(19) United States
(12) Patent Application Publication
(10) Pub. No.: US 2026/0259686 A1
(43) Pub. Date: Sep. 3, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Kouichi SUZUKI, Kanagawa (JP)

(73) Assignee: FUJIFILM Business Innovation Corp., Tokyo (JP)

(21) Appl. No.: 19/311,809

(22) Filed: Aug. 27, 2025

(30) Foreign Application Priority Data
Feb. 28, 2025 (JP) 2025-031636

(51) Int. Cl. G06F 3/12; H04N 1/393

(52) U.S. Cl. CPC G06F 3/1242; H04N 1/393

(57) ABSTRACT

An information processing system includes a processor configured to: in a case where an image is composed for input document data and printing is performed in accordance with setting information that is set for each size and orientation of a document and includes information about a position and an orientation of the image to be composed with the document, when change processing is performed on the input document data to change at least one of the size and the orientation of the document, convert content of the setting information in accordance with content of the change processing; and compose the image with the document data in accordance with the converted setting information.

### CROSS-REFERENCE TO RELATED APPLICATIONS

This application is based on and claims priority under 35 USC 119 from Japanese Patent Application No. 2025-031636 filed February 28, 2025.

### BACKGROUND

### i. Technical Field

The present disclosure relates to an information processing system and a non-transitory computer readable medium.

### ii. Related Art

Japanese Unexamined Patent Application Publication No. 08-018767 discloses an image forming apparatus that can set the position where a stamp is to be overprinted and change the stamp position in accordance with a different sheet size.

### SUMMARY

There is a disclosed wide image forming apparatus that can be loaded with sheets of a plurality of sizes and, when printing cannot be performed using a sheet corresponding to the size and the orientation of a document in input document data, can perform change processing to change at least one of the size and the orientation of the document and then perform printing using a substitute sheet with a size and an orientation different from those of the document.

There is a disclosed image composing function that composes an image, such as a stamp image, with input document data and performs printing in an image forming apparatus. The image composing function is a function that previously registers the setting information including information about the position and the orientation of an image to be composed with a document for each size and orientation of the document, composes the image for the input document data and performs printing in accordance with the registered setting information.

However, in a case where the image composing function is used in the wide image forming apparatus, when the change processing is performed on the document data and the image is composed with the document data in accordance with setting information, there is a problem in that the image is composed in a state different from what is expected.

Aspects of non-limiting embodiments of the present disclosure relate to providing an information processing system and a non-transitory computer readable medium that can compose an image as expected even when change processing is performed on input document data.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: in a case where an image is composed for input document data and printing is performed in accordance with setting information that is set for each size and orientation of a document and includes information about a position and an orientation of the image to be composed with the document, when change processing is performed on the input document data to change at least one of the size and the orientation of the document, convert content of the setting information in accordance with content of the change processing; and compose the image with the document data in accordance with the converted setting information.

### BRIEF DESCRIPTION OF THE DRAWINGS

Exemplary embodiments of the present disclosure will be described in detail based on the following figures, wherein:

FIG. 1 is a diagram illustrating a system configuration of an image forming system according to an exemplary embodiment;

FIG. 2 is a diagram illustrating substitute printing by an image forming apparatus;

FIG. 3 is a diagram illustrating substitute printing by the image forming apparatus;

FIG. 4 is a table illustrating an example of extension information in the image forming apparatus;

FIG. 5 is a block diagram illustrating a hardware configuration of the image forming apparatus;

FIG. 6 is a diagram illustrating an example of setting information in the image forming apparatus;

FIG. 7 is a diagram illustrating an image composing function of the image forming apparatus;

FIG. 8 is a diagram illustrating the image composing function of the image forming apparatus;

FIG. 9 is a diagram illustrating processing to convert setting information in the image forming apparatus;

FIG. 10 is a diagram illustrating processing to convert setting information in the image forming apparatus;

FIG. 11 is a diagram illustrating processing to convert setting information in the image forming apparatus;

FIG. 12 is a diagram illustrating processing to convert setting information in the image forming apparatus;

FIG. 13 is a diagram illustrating processing to convert setting information in the image forming apparatus; and

FIG. 14 is a flowchart illustrating a flow of processing when the image composing function of the image forming apparatus is used.

### DETAILED DESCRIPTION

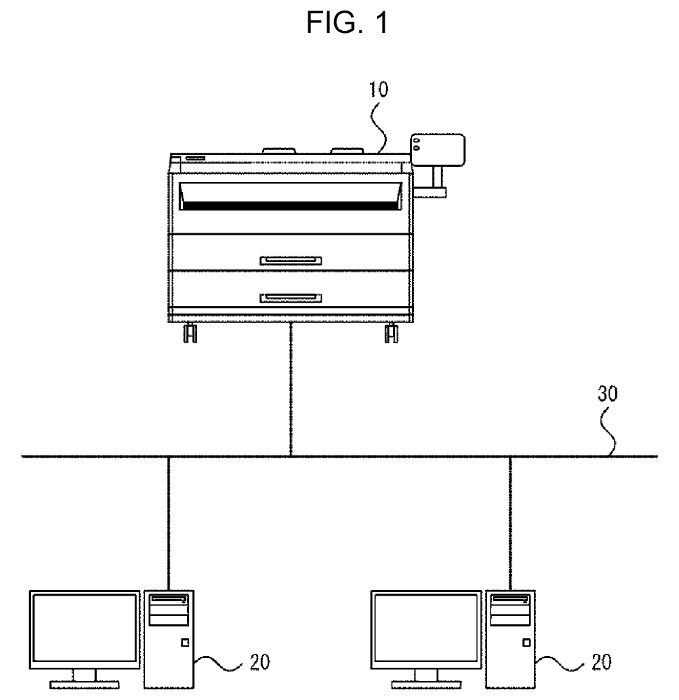

Exemplary embodiments for implementing the technology of the present disclosure will be described below in detail with reference to the drawings. FIG. 1 is a diagram illustrating a system configuration of an image forming system according to an exemplary embodiment.

As illustrated in FIG. 1, the image forming system according to the present exemplary embodiment includes an image forming apparatus 10 and a terminal device 20. The image forming apparatus 10 is an example of an information processing system according to the technology of the present disclosure.

The image forming apparatus 10 is a wide image forming apparatus that can be loaded with sheets of a plurality of sizes including roll sheets. The image forming apparatus 10 performs printing on the sheet corresponding to the size and the orientation of the document in the document data input from the terminal device 20.

When the sheets corresponding to the size and the orientation of the document in the document data input from the terminal device 20 are not loaded, the image forming apparatus 10 can perform printing using substitute sheets.

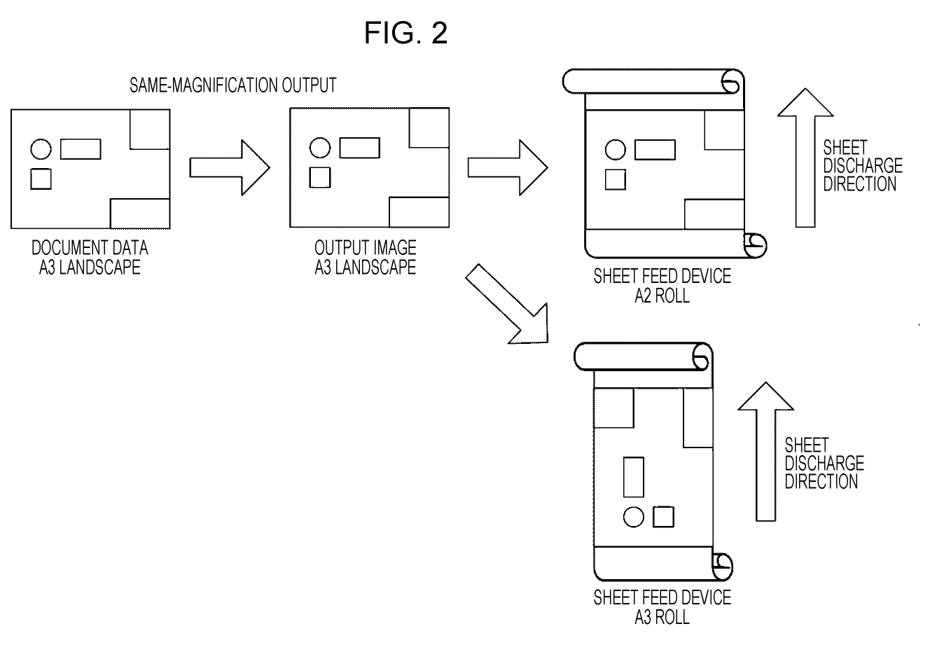

For example, as illustrated in FIG. 2, when the size and the orientation of the document in the document data are A3 landscape and the image forming apparatus 10 is not loaded with A3 landscape sheets, the image forming apparatus 10 can perform printing on an A2 roll sheet in the landscape orientation or perform change processing to change the orientation of the document and then perform printing on an A3 roll sheet in the portrait orientation.

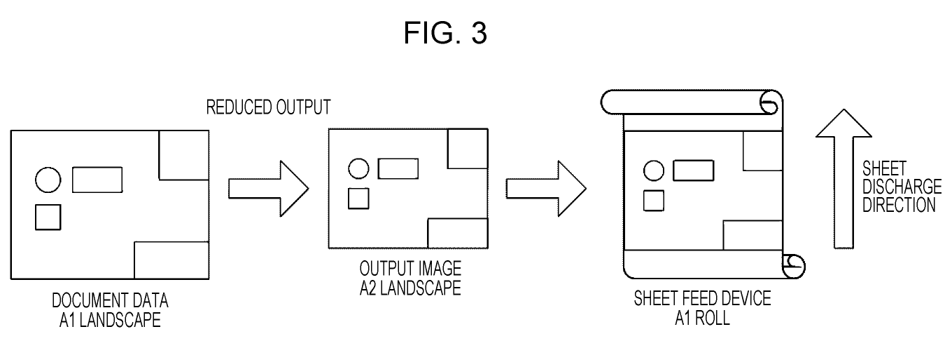

As illustrated in FIG. 3, when the size and the orientation of the document in the document data are A1 landscape and the image forming apparatus 10 is not loaded with A1 landscape sheets, the image forming apparatus 10 can perform change processing to change the size of the document to A2 and then perform printing on an A1 roll sheet in the landscape orientation.

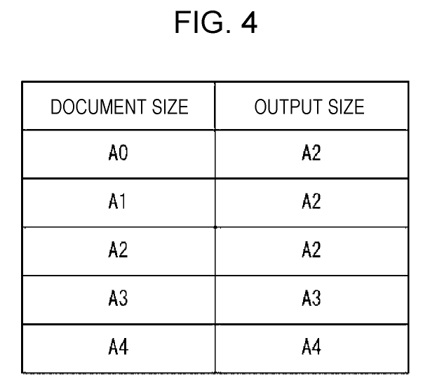

In this case, the sizes to which the document is changed are not particularly limited, and for example, as illustrated in FIG. 4, the size may be determined with reference to extension information that defines the relationship between a document size and an output size, or may be changed to the largest size among the compatible sizes.

The terminal device 20 is connected to the image forming apparatus 10 via a network 30. The terminal device 20 is a terminal for operating the image forming apparatus 10. The terminal device 20 generates print data and transmits the print data to the image forming apparatus 10. The terminal device 20 is implemented by, for example, a computer or a smartphone.

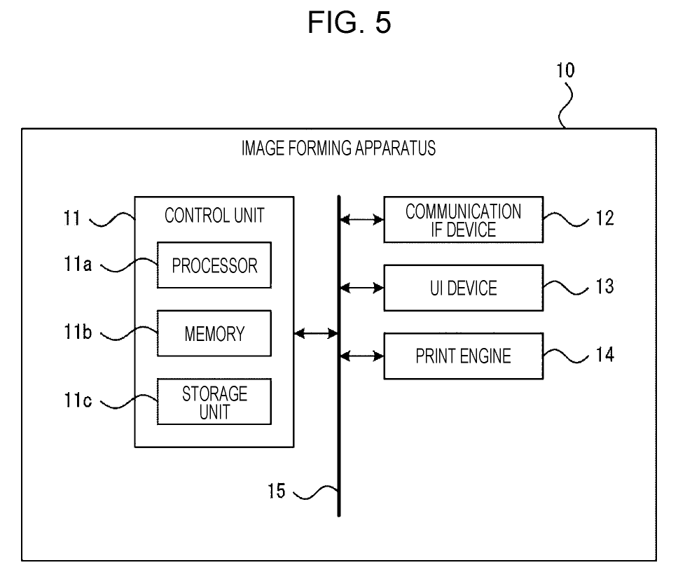

Next, a hardware configuration of the image forming apparatus 10 according to the present exemplary embodiment will be described. FIG. 5 is a block diagram illustrating the hardware configuration of the image forming apparatus 10.

As illustrated in FIG. 5, the image forming apparatus 10 includes a control unit 11, a communication interface (IF) device 12, a user interface (UI) device 13, and a print engine 14. These components are connected to each other via a control bus 15.

The control unit 11 includes a processor 11a, a memory 11b, and a storage unit 11c. The processor 11a executes predetermined processing based on a program that is read from the storage unit 11c and loaded to the memory 11b. The storage unit 11c includes, for example, a ROM, an HDD, or an SSD. The storage unit 11c stores various programs, data, etc.

In the description according to the present exemplary embodiment, the processor 11a reads and executes the program stored in the storage unit 11c, but this is not a limitation. The program may be provided in a form of being recorded in the computer-readable recording medium as described above. Further, the program may be acquired from an external device via a communication line.

The communication IF device 12 transmits and receives data to and from an external device or the like. The UI device 13 is, for example, a device for a user to receive or input information, such as a touch panel and/or a button. The print engine 14 prints an image on a recording medium such as a print sheet.

With the image forming apparatus 10 according to the present exemplary embodiment, it is possible to use an image composing function that composes an image such as a stamp image for the input document data and performs printing. With the image composing function, setting information including information about the position and the orientation of an image to be composed with a document is previously registered for each size and orientation of the document, and an image is composed for input document data and printed in accordance with the registered setting information.

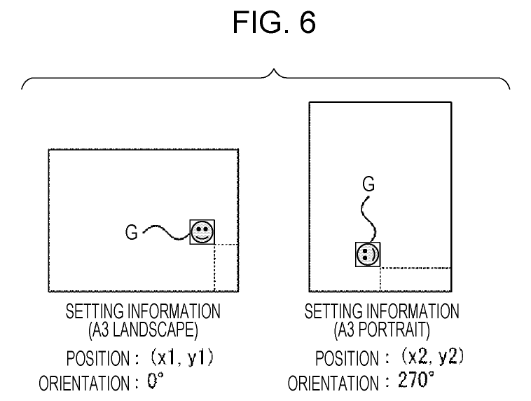

According to the present exemplary embodiment, as illustrated in FIG. 6, for example, the setting information includes, for each size and orientation of the document, information about relative coordinates from a reference position (e.g., the lower right position in FIG. 6) as information about the position of an image G to be composed and information about a rotation angle in a case of clockwise rotation from a reference direction (e.g., the upward direction in FIG. 6) as information about the orientation.

However, in a case where the image composing function is used in the wide image forming apparatus 10, when the above-described change processing is performed on the document data and the image G is composed with the document data in accordance with the setting information, there is a possibility that the image is composed in a state different from what is expected.

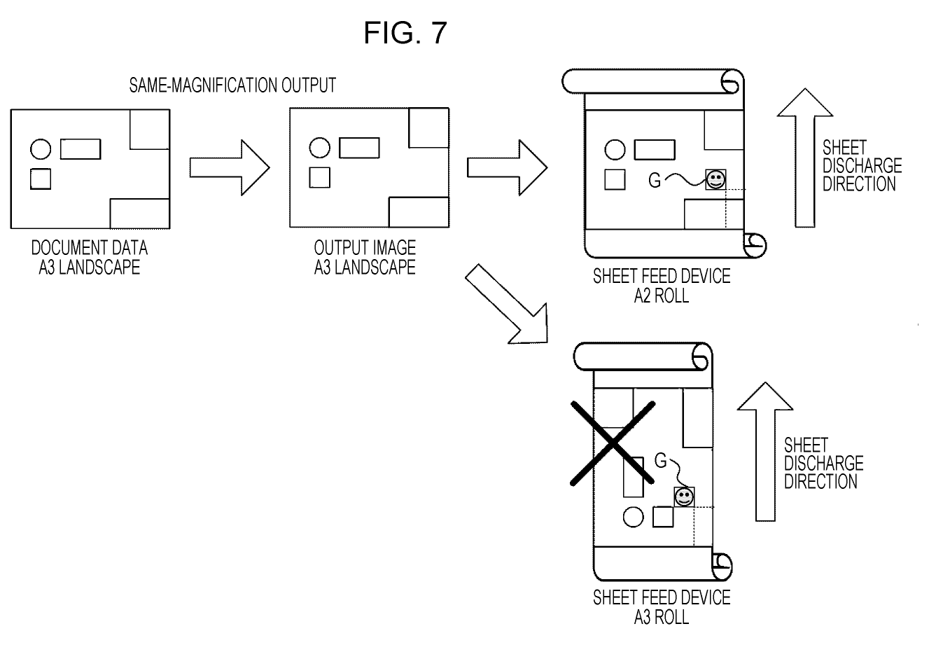

For example, as illustrated in FIG. 7, a description will be given of a case where the size and the orientation of the document in the document data are A3 landscape and no sheets of A3 landscape are loaded in the image forming apparatus 10.

In this case of printing on an A2 roll sheet in the landscape orientation without changing the size and the orientation of the document, when the image G is composed for the input document data and printing is performed in accordance with the setting information, the images are composed as expected.

However, in a case where the change processing is performed to change the document orientation and then printing is performed on an A3 roll sheet in the portrait orientation, when the image G is composed for the input document data in accordance with the setting information and printing is performed, the images are composed in a state different from what is expected.

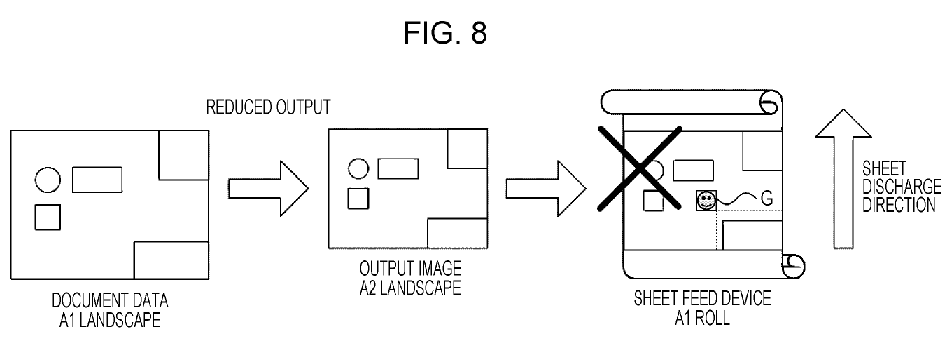

As illustrated in FIG. 8, a case where the size and the orientation of the document in the document data are A1 landscape and the image forming apparatus 10 is not loaded with A1 landscape sheets will be described.

In this case where the change processing is performed to change the document size to A2 and then printing is performed on an A1 roll sheet in the landscape orientation, when the image G is composed for the input document data in accordance with the setting information and printing is performed, the images are composed in a state different from what is expected.

In order to prevent such a problem, in a case where the control unit 11 of the image forming apparatus 10 according to the present exemplary embodiment composes the image for the input document data by using the above-described image composing function and performs printing, when the change processing is performed to change at least one of the size and the orientation of the document on the input document data, the control unit 11 converts the content of the setting information in accordance with the content of the change processing and composes the image with the document data in accordance with the converted setting information.

With regard to the conversion of the content of the setting information, specifically, when the control unit 11 performs the change processing to enlarge or reduce the document size, the control unit 11 converts the distance from the reference position to the composing position in accordance with the enlargement or reduction ratio of the document size. With regard to the information about the distance from the reference position to the composing position, the setting information may include the information about the distance itself, and the information about the distance from the reference position to the composing position included in the setting information may be the information about the distance itself or the position information about the reference position and the composing position for calculating the distance.

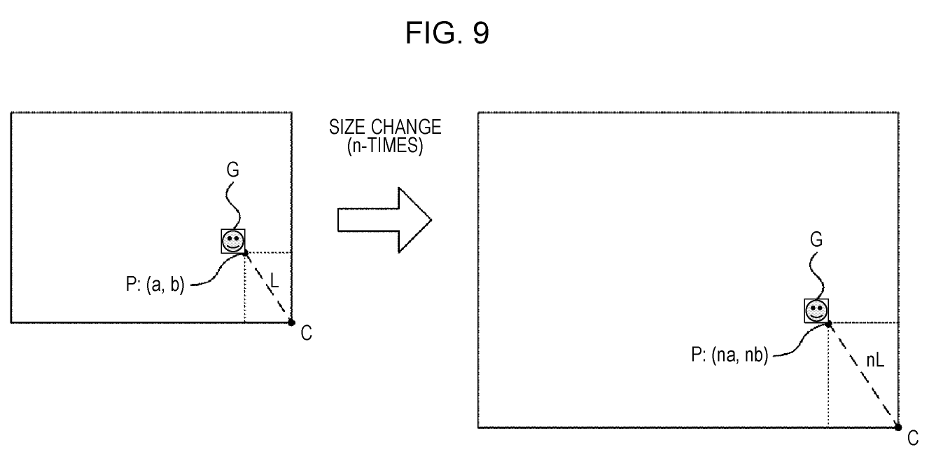

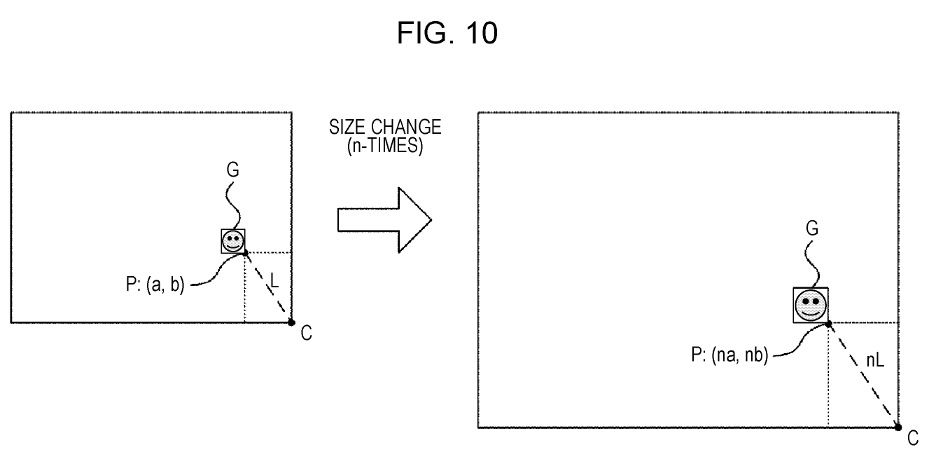

For example, as illustrated in FIG. 9, when the output size is set to be n times the document size, the coordinates of a composing position P are converted so that a distance L from a reference position C to the composing position P is n times. In this case, as illustrated in FIG. 10, the control unit 11 may convert the size of the image G to be composed in accordance with the enlargement or reduction ratio.

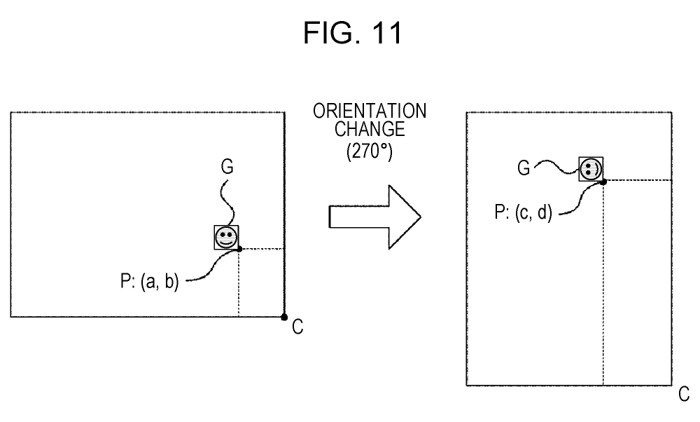

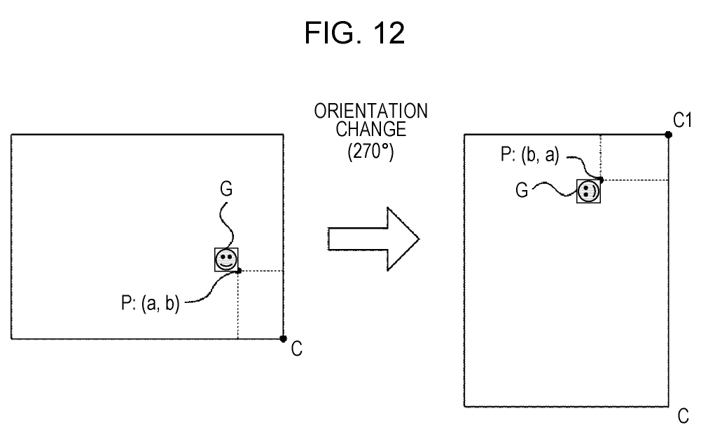

When performing the change processing to change the document orientation, the control unit 11 converts the orientation of the image G to be composed in accordance with the orientation of the document after change. For example, as illustrated in FIG. 11, when the document orientation is rotated clockwise by 270°, the coordinates of the composing position P may be converted into the corresponding position without changing the reference position C. As illustrated in FIG. 12, the reference position C may be changed and the coordinates of the composing position P may be converted into the corresponding position.

As described above, by converting the content of the setting information and composing, the image is composed as expected even when the change processing is performed to change at least one of the size and the orientation of the document on the document data.

The control unit 11 may record history information of printing processing and, when the user changes at least one of the position and the orientation of the image to be composed with the document with regard to the printing result of the printing processing, may change the content of the setting information corresponding to the document data input in the printing processing in accordance with the content changed by the user.

In this case, the control unit 11 may change the content of the setting information corresponding to the document data input in the printing processing in accordance with the content changed by the user and the content of the change processing performed in the printing processing.

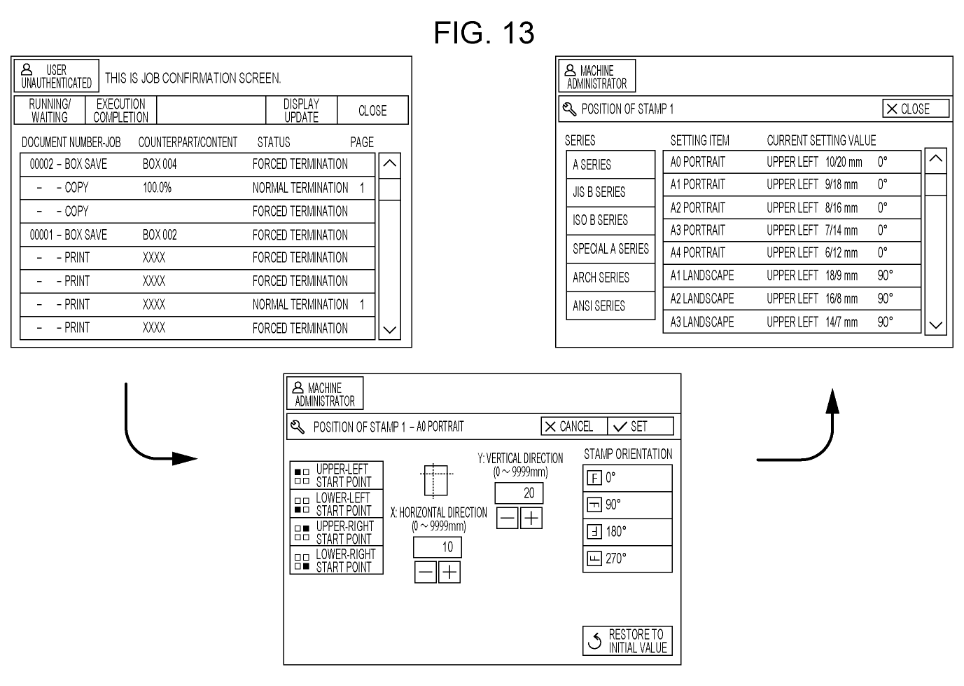

Specifically, as illustrated in the upper left part of FIG. 13, when the user selects the history of the printing processing corresponding to a printed material from the history screen of the printing processing (displayed as "job" in FIG. 13), the control unit 11 can acquire information about the document size, output size, type of composed image, setting information, and the like, of the printing processing from the history information of the printing processing.

As illustrated in the lower part of FIG. 13, the control unit 11 receives editing of the position and the orientation of the image to be composed in the output size so that the user can modify the setting information based on the printed material.

As illustrated in the upper right part of FIG. 13, the control unit 11 applies the received information about the position and the orientation of the image to be composed in the output size to the setting information about the size and the orientation of another document.

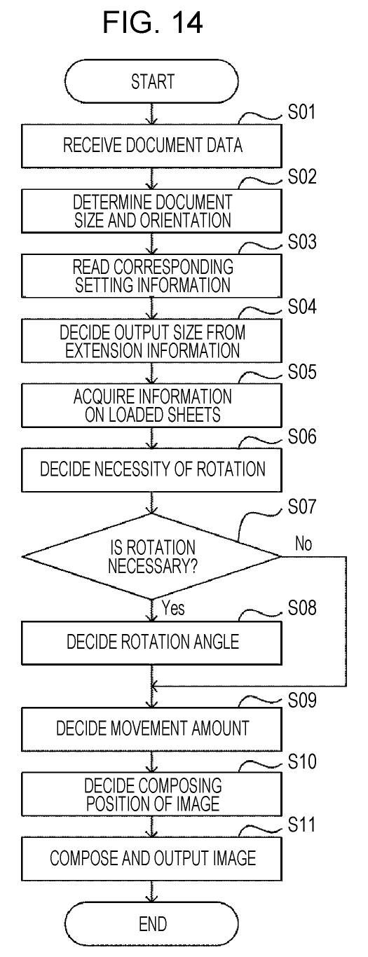

With reference to the flowchart of FIG. 14, the following describes the flow of processing performed by the image forming apparatus 10 according to the present exemplary embodiment when the image composing function is used.

First, in step S01, the control unit 11 of the image forming apparatus 10 receives the document data.

Next, in step S02, the control unit 11 determines the size and the orientation of the document in the document data.

Next, in step S03, the control unit 11 reads the setting information corresponding to the size and the orientation of the document.

Next, in step S04, the control unit 11 decides the output size from the extension information.

Next, in step S05, the control unit 11 acquires information about sheets loaded in the image forming apparatus 10.

Next, in step S06, the control unit 11 decides the necessity of rotation as change processing.

Next, in step S07, the control unit 11 determines whether the rotation is necessary.

When it is determined in step S07 that the rotation is necessary, the control unit 11 decides the rotation angle in step S08. When it is determined in step S07 that rotation is not necessary, the control unit 11 proceeds to step S09.

Next, in step S09, the control unit 11 decides the movement amount of the composing position and, in step S10, decides the composing position of the image.

Next, in step S11, the control unit 11 composes and outputs the images and ends the processing.

### Modification

While the image forming system according to an exemplary embodiment of the present disclosure has been described above, the technology of the present disclosure is not limited to the above-described exemplary embodiment and may be modified as appropriate.

According to the above exemplary embodiment, the processor refers to a processor in a broad sense and includes general-purpose processors (for example, central processing unit (CPU)) and dedicated processors (for example, graphics processing unit (GPU), application specific integrated circuit (ASIC), field programmable gate array (FPGA), and programmable logic devices).

In addition, the operation of the processor according to the exemplary embodiment described above may be performed not only by one processor but also by a plurality of processors existing at physically separated positions in cooperation with each other. The order of operations of the processor is not limited to one described in the embodiments above, and may be changed.

In the technology according to the present disclosure, the system includes both a system configured by a plurality of apparatuses and a system configured by a single apparatus.

The technique of the present disclosure can also be applied to a program and a program product.

### Appendix

(((1)))

An information processing system comprising:

a processor configured to:

in a case where an image is composed for input document data and printing is performed in accordance with setting information that is set for each size and orientation of a document and includes information about a position and an orientation of the image to be composed with the document,

when change processing is performed on the input document data to change at least one of the size and the orientation of the document,

convert content of the setting information in accordance with content of the change processing; and

compose the image with the document data in accordance with the converted setting information.

(((2)))

The information processing system according to (((1))), wherein

the setting information includes information about a distance from a reference position to a composing position as information about a position of the image to be composed, and

the processor is configured to, when change processing is performed to enlarge or reduce the size of the document, convert the distance from the reference position to the composing position in accordance with an enlargement or reduction ratio of the size of the document.

(((3)))

The information processing system according to (((2))), wherein when change processing is performed to enlarge or reduce the size of the document, the processor is configured to convert the size of the image to be composed in accordance with an enlargement or reduction ratio of the size of the document.

(((4)))

The information processing system according to any one of (((1))) to (((3))), wherein when change processing is performed to change the orientation of the document, the processor is configured to convert the orientation of the image to be composed in accordance with the orientation of the document after change.

(((5)))

The information processing system according to any one of (((1))) to (((4))), wherein the processor is configured to:

record history information of printing processing; and

when a user changes at least one of the position and the orientation of the image to be composed with the document with respect to a printing result of the printing processing,

change content of the setting information corresponding to the document data input in the printing processing in accordance with content changed by a user.

(((6)))

The information processing system according to (((5))), wherein the processor is configured to change the content of the setting information corresponding to the document data input in the printing processing in accordance with the content changed by the user and the content of the change processing performed in the printing processing.

(((7)))

A program causing a computer to execute a process comprising:

in a case where an image is composed for input document data and printing is performed in accordance with setting information that is set for each size and orientation of a document and includes information about a position and an orientation of the image to be composed with the document,

when change processing is performed on the input document data to change at least one of the size and the orientation of the document,

converting content of the setting information in accordance with content of the change processing; and

composing the image with the document data in accordance with the converted setting information.

What is claimed is:

1. An information processing system comprising:
a processor configured to:
in a case where an image is composed for input document data and printing is performed in accordance with setting information that is set for each size and orientation of a document and includes information about a position and an orientation of the image to be composed with the document,
when change processing is performed on the input document data to change at least one of the size and the orientation of the document,
convert content of the setting information in accordance with content of the change processing; and
compose the image with the document data in accordance with the converted setting information.

2. The information processing system according to claim 1, wherein
the setting information includes information about a distance from a reference position to a composing position as information about a position of the image to be composed, and
the processor is configured to, when change processing is performed to enlarge or reduce the size of the document, convert the distance from the reference position to the composing position in accordance with an enlargement or reduction ratio of the size of the document.

3. The information processing system according to claim 2, wherein when change processing is performed to enlarge or reduce the size of the document, the processor is configured to convert the size of the image to be composed in accordance with an enlargement or reduction ratio of the size of the document.

4. The information processing system according to claim 1, wherein when change processing is performed to change the orientation of the document, the processor is configured to convert the orientation of the image to be composed in accordance with the orientation of the document after change.

5. The information processing system according to claim 1, wherein the processor is configured to:
record history information of printing processing; and
when a user changes at least one of the position and the orientation of the image to be composed with the document with respect to a printing result of the printing processing,
change content of the setting information corresponding to the document data input in the printing processing in accordance with content changed by a user.

6. The information processing system according to claim 5, wherein the processor is configured to change the content of the setting information corresponding to the document data input in the printing processing in accordance with the content changed by the user and the content of the change processing performed in the printing processing.

7. A non-transitory computer readable medium storing a program causing a computer to execute a process comprising:
in a case where an image is composed for input document data and printing is performed in accordance with setting information that is set for each size and orientation of a document and includes information about a position and an orientation of the image to be composed with the document,
when change processing is performed on the input document data to change at least one of the size and the orientation of the document,
converting content of the setting information in accordance with content of the change processing; and
composing the image with the document data in accordance with the converted setting information.
